(19) United States
(12) Patent Application Publication
(10) Pub. No.: US 2025/0015861 A1
(43) Pub. Date: Jan. 9, 2025

(54) METHOD AND APPARATUS FOR REPORTING AND RECEIVING CHANNEL STATE INFORMATION

(71) Applicant: FUJITSU LIMITED, Kawasaki-shi (JP)

(72) Inventors: Xin WANG, Beijing (CN); Gang SUN, Beijing (CN); Jian ZHANG, Beijing (CN); Meiyi JIA, Beijing (CN)

(73) Assignee: FUJITSU LIMITED, Kawasaki-shi (JP)

(21) Appl. No.: 18/897,629

(22) Filed: Sep. 26, 2024

Related U.S. Application Data
(63) Continuation of application No. PCT/CN2022/084507, filed on Mar. 31, 2022.

(51) Int. Cl. H04B 7/06; H04W 24/10

(52) U.S. Cl. CPC H04B 7/0626; H04W 24/10

(57) ABSTRACT

An apparatus for reporting channel state information (CSI) includes: a first receiver configured to receive one or more reference signals to obtain measurement information; first processor circuitry configured to obtain CSI according to the measurement information; and a first transmitter configured to transmit the CSI at a first time according to CSI report configuration, wherein the CSI at least indicates a channel state of a second time which is later than the first time.

### CROSS-REFERENCE TO RELATED APPLICATION

This application is a continuation application of International Application PCT/CN2022/084507 filed on Mar. 31, 2022, and designated the U.S., the entire contents of which are incorporated herein by reference.

### TECHNICAL FIELD

Embodiments of the present disclosure generally relate to the field of communications.

### BACKGROUND

This section introduces aspects that may facilitate better understanding of the present disclosure. Accordingly, the statements of this section are to be read in this light and are not to be understood as admissions about what is in the related art or what is not in the related art.

As a popular technique in recent years, artificial intelligence (AI) and/or machine learning (ML) have been applied to many application areas, such as image processing, video processing, natural language processing, automotive driving. The studies and discussions of applying AI/ML to 3GPP standards and mobile systems are also becoming popular.

In the working groups of radio access network (RAN) in 3GPP, there is a study item “study on enhancement for data collection for NR and ENDC” in RAN3 in Rel-17. In Rel-18, it is endorsed as a work item. Besides, AI/ML for air interface has been widely discussed among companies. It was concluded as a study item in Rel-18 led by RAN1. Furthermore, it is foreseen that AI/ML will have bigger impacts in future 6G standard and wireless networks.

AI/ML based approach can be applied to many use cases, such as channel state information (CSI) feedback, beam management, positioning, etc. As a substitute of related method, AI/ML can bring significant gain over related methods with regard to KPIs like overhead reduction, performance enhancement, latency reduction etc.

For a data driven method, AL/ML models are trained offline with the data generated from simulation and/or field data. Also, online training can be supported in some use cases. In this way, AI/ML models are able to be updated and with high adaptivity to its applying scenarios.

On the other hand, link adaptation techniques are widely used in mobile communication systems, such as LTE, LTE-A, and NR. Also, it will be applied to future 6G systems. In order to make transmission scheme being able to shape according to fading channel conditions, a terminal equipment side may feedback channel state information (CSI) to a network device side.

Then the network device side will utilize such information to decide modulation and coding scheme (MCS), multiple input multiple output (MIMO) parameters (layer e.g.), precoding/beamforming etc. for its downlink transmission. Similarly, link adaptation methods are also utilized in uplink direction. Besides feedback-based method, sounding reference signal (SRS) based method using time division duplex (TDD) reciprocity is also a popular method for link adaptation.

### SUMMARY

The summary is provided to introduce a selection of concepts in a simplified form that are further described below in detailed description. This summary is not intended to identify key features or essential features of the claimed subject matter, nor is it intended to be used to limit the scope of the claimed subject matter.

The inventors found that one challenge to these closed loop link adaptation methods comes from latency between channel measurements and data transmission based on measurement results. In some application scenarios, such as high mobility scenarios, the channel state (channel coefficients e.g.) may have significant change due to the latency. Consequently, performance gain from link adaptation would be reduced.

In order to solve at least part of the above problems, methods, apparatus, devices and computer programs are provided in the present disclosure. It may be appreciated that embodiments of the present disclosure are not limited to a wireless system operating in NR network, but could be more widely applied to any application scenario where similar problems exist.

In general, embodiments of the present disclosure provide a method and apparatus for reporting and receiving CSI. It is expected to obtain accuracy CSI for downlink transmission.

According to an aspect of the embodiments of this disclosure, there is provided a method for reporting CSI. The method includes:

receiving, by a terminal equipment, one or more reference signals to obtain measurement information;

obtaining CSI according to the measurement information; and

transmitting the CSI at a first time according to CSI report configuration, wherein the CSI at least indicates a channel state of a second time which is later than the first time.

According to another aspect of the embodiments of this disclosure, there is provided an apparatus for reporting channel state information (CSI), including:

a first receiving unit configured to receive one or more reference signals to obtain measurement information;

a first processing unit configured to obtain CSI according to the measurement information; and

a first transmitting unit configured to transmit the CSI at a first time according to CSI report configuration, wherein the CSI at least indicates a channel state of a second time which is later than the first time.

According to another aspect of the embodiments of this disclosure, there is provided a method for receiving channel state information (CSI), including:

transmitting, by a network device, one or more reference signals according to reference signal resource configuration; and

receiving CSI at a first time, wherein the CSI at least indicates a channel state of a second time which is later than the first time.

According to another aspect of the embodiments of this disclosure, there is provided an apparatus for receiving channel state information (CSI), including:

a second transmitting unit configured to transmit one or more reference signals according to reference signal resource configuration; and

a second receiving unit configured to receive CSI at a first time, wherein the CSI at least indicates a channel state of a second time which is later than the first time.

According to another aspect of the embodiments of this disclosure, there is provided a network system, including:

a terminal equipment configured to receive one or more reference signals to obtain measurement information; obtain CSI according to the measurement information; and transmit the CSI at a first time according to CSI report configuration; and

a network device configured to transmit one or more reference signals according to reference signal resource configuration; and receive the CSI at the first time; wherein the CSI at least indicates a channel state of a second time which is later than the first time.

According to various embodiments of the present disclosure, a terminal equipment receives one or more reference signals to obtain measurement information; obtains CSI according to the measurement information; and transmits the CSI at a first time according to CSI report configuration, wherein the CSI at least indicates a channel state of a second time which is later than the first time. Therefore, the network device side can obtain CSI matching to a channel status of a time instance of a downlink transmission using the CSI.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram which shows a wireless communication network;

FIG. 2 is a schematic diagram which shows reference signals and a fading channel;

FIG. 3 is a schematic diagram which shows a method for reporting CSI in accordance with an embodiment of the present disclosure;

FIG. 4 is a schematic diagram of an AI/ML module in the terminal equipment;

FIG. 5 is a schematic diagram which shows reference signals and a downlink transmission;

FIG. 6 is another schematic diagram which shows reference signals and a downlink transmission;

FIG. 7 is another schematic diagram which shows reference signals and a downlink transmission;

FIG. 8 is another schematic diagram which shows a method for reporting CSI in accordance with an embodiment of the present disclosure;

FIG. 9 is another schematic diagram which shows a method for reporting CSI in accordance with an embodiment of the present disclosure;

FIG. 10 is another schematic diagram which shows a method for reporting CSI in accordance with an embodiment of the present disclosure;

FIG. 11 is another schematic diagram which shows a method for reporting CSI in accordance with an embodiment of the present disclosure;

FIG. 12 is another schematic diagram which shows a method for reporting CSI in accordance with an embodiment of the present disclosure;

FIG. 13 is another schematic diagram which shows a method for reporting CSI in accordance with an embodiment of the present disclosure;

FIG. 14 is another schematic diagram which shows a method for reporting CSI in accordance with an embodiment of the present disclosure;

FIG. 15 is another schematic diagram which shows a method for reporting CSI in accordance with an embodiment of the present disclosure;

FIG. 16 is another schematic diagram which shows a method for reporting CSI in accordance with an embodiment of the present disclosure;

FIG. 17 is another schematic diagram which shows a method for reporting CSI in accordance with an embodiment of the present disclosure;

FIG. 18 is another schematic diagram which shows a method for reporting CSI in accordance with an embodiment of the present disclosure;

FIG. 19 shows a block diagram of an apparatus for reporting CSI in accordance with an embodiment of the present disclosure;

FIG. 20 shows a block diagram of an apparatus for receiving CSI in accordance with an embodiment of the present disclosure;

FIG. 21 is a schematic diagram of the network device of an embodiment of this disclosure; and

FIG. 22 is a schematic diagram of the terminal equipment of an embodiment of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

As used herein, the term “wireless communication network” refers to a network following any suitable communication standards, such as LTE-Advanced (LTE-A), LTE, Wideband Code Division Multiple Access (WCDMA), High-Speed Packet Access (HSPA), and so on. Furthermore, the communications between a terminal device and a network device in the wireless communication network may be performed according to any suitable generation communication protocols, including, but not limited to, Global System for Mobile Communications (GSM), Universal Mobile Telecommunications System (UMTS), Long Term Evolution (LTE), and/or other suitable, and/or other suitable the first generation (1G), the second generation (2G), 2.5G, 2.75G, the third generation (3G), the fourth generation (4G), 4.5G, the future fifth generation (5G) communication protocols, the future 6th generation (6G) communication protocols, wireless local area network (WLAN) standards, such as the IEEE 802.11 standards; and/or any other appropriate wireless communication standard, such as the Worldwide Interoperability for Microwave Access (WiMAX), Bluetooth, and/or ZigBee standards, and/or any other protocols either currently known or to be developed in the future.

The term “network device” refers to a device in a wireless communication network via which a terminal device accesses the network and receives services therefrom. The network device refers a base station (BS), an access point (AP), or any other suitable device in the wireless communication network. The BS may be, for example, a node B (NodeB or NB), an evolved NodeB (eNodeB or eNB), or gNB, a CU, a DU, a RU, a Remote Radio Unit (RRU), a radio header (RH), a remote radio head (RRH), a relay, a low power node such as a femto, a pico, and so forth. Yet further examples of the network device may include multi-standard radio (MSR) radio equipment such as MSR BSs, network controllers such as radio network controllers (RNCs) or base station controllers (BSCs), base transceiver stations (BTSs), transmission points, transmission nodes, a central signal processing pool or a central computing pool of a base station or several base stations. More generally, however, the network device may represent any suitable device (or group of devices) capable, configured, arranged, and/or operable to enable and/or provide a terminal device access to the wireless communication network or to provide some service to a terminal device that has accessed the wireless communication network.

The term “terminal equipment” refers to any end device that can access a wireless communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, portable computers, image capture terminal devices such as digital cameras, gaming terminal devices, music storage and playback appliances, a mobile phone, a cellular phone, a smart phone, voice over IP (VOIP) phones, wireless local loop phones, a tablet, a wearable device, a personal digital assistant (PDA), portable computers, desktop computer, image capture terminal devices such as digital cameras, gaming terminal devices, music storage and playback appliances, wearable terminal devices, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal device”, “terminal”, “user equipment” and “UE” may be used interchangeably.

As one example, a terminal device may represent a UE configured for communication in accordance with one or more communication standards promulgated by the 3rd Generation Partnership Project (3GPP), such as 3GPP's GSM, UMTS, LTE, and/or 5G standards, and/or 6G standards. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the wireless communication network. Instead, a UE may represent a device that is intended for sale to, or operation by, a human user but that may not initially be associated with a specific human user.

The terminal device may support device-to-device (D2D) communication or V2X communication, for example by implementing a 3GPP standard for sidelink communication, and may in this case be referred to as a D2D communication device or V2X communication device.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

As used herein, a downlink, DL transmission refers to a transmission from the network device to a terminal device, and an uplink, UL transmission refers to a transmission in an opposite direction.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

Now some exemplary embodiments of the present disclosure will be described below with reference to the figures.

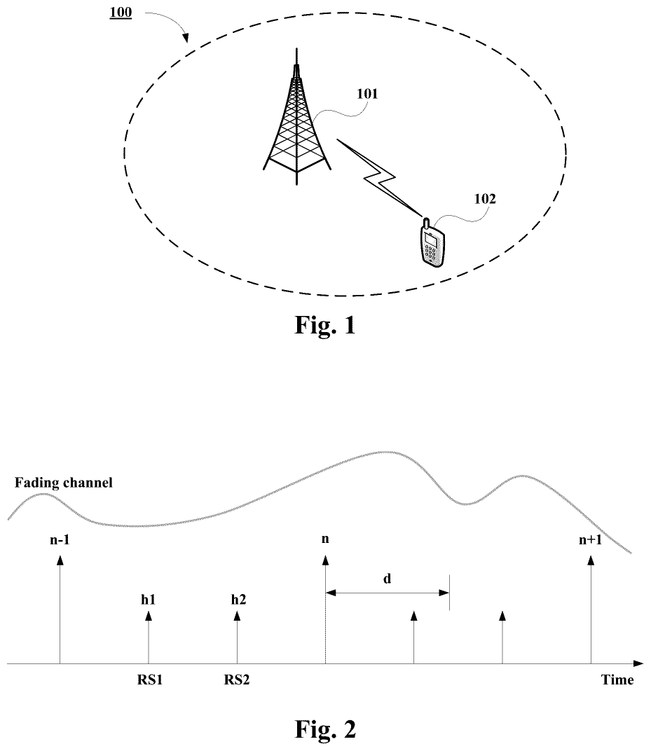

Reference is first made to FIG. 1, FIG. 1 shows a schematic diagram of a wireless communication network 100 in which embodiments of the disclosure may be implemented. As shown in FIG. 1, the wireless communication network 100 may include one or more network devices, for example network devices 101.

It will be appreciated that the network device 101 could also be in a form of gNB, CU (Centralized Unit), DU (Distributed Unit), RU (Radio Unit), IAB Donor, IAB Node, Relay, repeater, network-controlled repeaters, Node B, eNB, BTS (Base Transceiver Station), and/or BSS (Base Station Subsystem), access point (AP) and the like. The network device 101 may provide radio connectivity to a set of terminal devices or UEs 102-1, 102-2, . . . , 102-N(collectively referred to as “terminal equipment(s) 102) within its coverage, where N is a natural number.

The network device 101 includes processing circuitry, device readable medium, interface, user interface equipment, auxiliary equipment, power source, power delivery circuitry, and antenna. These components are depicted as single boxes located within a single larger box, and in some cases, contain additional boxes therein.

In practice, however, the network device 101 may include multiple different physical components that make up a single illustrated component (e.g., interface includes ports/terminals for coupling wires for a wired connection and radio front end circuitry for a wireless connection). As another example, the network device 101 may be a virtual network node. Similarly, a network node may be composed of multiple physically separate components (e.g., a NodeB component and an RNC component, a BTS component and a BSC component, etc.), which may each have their own respective components.

In certain scenarios in which the network device 101 includes multiple separate components (e.g., BTS and BSC components), one or more of the separate components may be shared among several network nodes. For example, a single RNC may control multiple NodeBs. In such a scenario, each unique NodeB and RNC pair may in some instances be considered a single separate network node. In some embodiments, a network node may be configured to support multiple radio access technologies (RATs). In such embodiments, some components may be duplicated (e.g., separate device readable medium for the different RATs) and some components may be reused (e.g., the same antenna may be shared by the RATs).

Although the network device 101 illustrated in the example wireless communication network may represent a device that includes a particular combination of hardware components, other embodiments may include network nodes with different combinations of components. It is to be understood that a network device may include any suitable combination of hardware and/or software needed to perform the tasks, features, functions and methods disclosed herein.

It is to be understood that the configuration of FIG. 1 is described merely for the purpose of illustration, without suggesting any limitation as to the scope of the present disclosure. Those skilled in the art would appreciate that the wireless communication network 100 may include any suitable number of terminal devices and/or network devices and may have other suitable configurations.

Radio channels in radio access network (RAN) obey principles of electromagnetic wave propagation. For wideband systems with massive MIMO antenna techniques, however, it is almost impossible to derive an analytical closed-form solution for a radio channel link between a network device and a terminal equipment. The way to estimate channel coefficients is using reference signal (RS) for deducing its neighbouring channel coefficients.

Furthermore, kinds of measures on channel state information are controlled by a network device, and CSI is fed back from a terminal equipment via air interface. CSI includes such as channel quality indicator (CQI), precoding matrix indicator (PMI), CSI-RS resource indicator (CRI), SS/PBCH block resource indicator (SSBRI), layer indicator (LI), rank indicator (RI), L1-RSRP or L1-SINR. In the network device, these CSI are used to optimize downlink transmission with MCS, precoding matrix, and beam adapting to a fading channel instantaneously.

FIG. 2 is a schematic diagram which shows reference signals and a fading channel. As shown in FIG. 2, the terminal equipment receives RS1 and RS2, then CSI is derived from RS1 and RS2 according to CSI measurement. The CSI is reported to the network device at time instance n, and downlink transmission using the feedback CSI is performed at time instance n+d.

However, as shown in FIG. 2, the channel state may change a lot during this period due to latency (or called CSI delay). The pre-processing of downlink transmission (precoding, e.g.) based on these outdated CSI cannot bring performance gain as the expectation to a closed-loop radio optimization.

### First Aspect of Embodiments

A method for reporting CSI is provided in the disclosure.

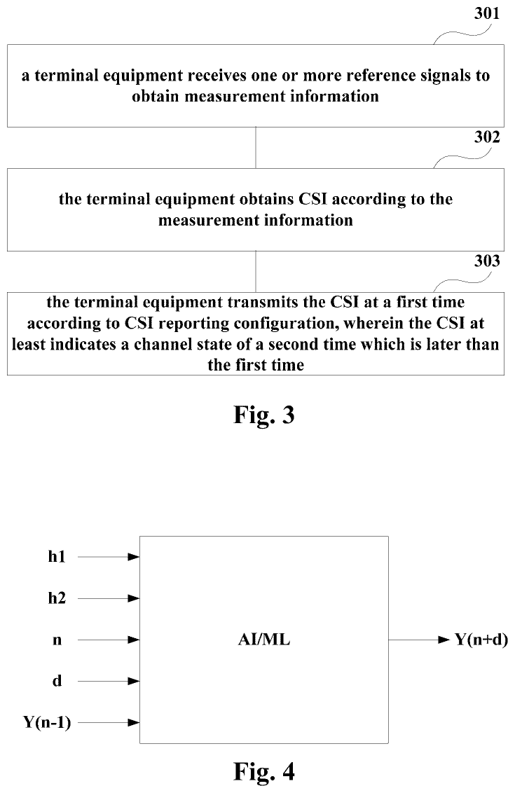

FIG. 3 is a schematic diagram which shows a method for reporting CSI in accordance with an embodiment of the present disclosure, and illustrates the method in a terminal equipment side as an example.

As shown in FIG. 3, the method includes:

301, a terminal equipment receives one or more reference signals to obtain measurement information;

302, the terminal equipment obtains CSI according to the measurement information; and

303, the terminal equipment transmits the CSI at a first time according to CSI report configuration, wherein the CSI at least indicates a channel state of a second time which is later than the first time.

It should be appreciated that FIG. 3 is only an example of the disclosure, it is not limited thereto. For example, the order of operations or steps may be adjusted and/or some operations or steps may be omitted. Moreover, some operations or steps not shown in FIG. 3 may be added.

For example, the first time is a time instance at which the CSI is transmitted by the terminal equipment, the second time is a time instance at which a downlink transmission using the CSI (precoding, modulation and coding scheme, e.g.) is transmitted by the network device, and it is not limited thereto.

Therefore, a terminal equipment receives one or more reference signals to obtain measurement information; obtains CSI according to the measurement information; and transmits the CSI at a first time according to CSI report configuration, wherein the CSI at least indicates a channel state of a second time which is later than the first time. Therefore, the network device side can obtain the CSI matching to the channel status of the time instance of the downlink transmission using this CSI.

In some embodiments, CSI prediction is a way to mitigate performance degradation from CSI feedback delay. It is well known that time series prediction is a typical application area of AI/ML. Neural networks such as RNN, LSTM, transformer etc. have performance gain over related methods.

In some embodiments, CSI prediction is realized by CSI measurement function directly with the information of CSI delay. AI/ML can be used to generate accurate measurement or prediction results.

In some embodiments, the terminal equipment receives, from the network device, CSI report configuration and/or reference signal resource configuration. Then, the network device transmits one or more reference signals according to the reference signal resource configuration. The terminal equipment receives the one or more reference signals and perform CSI measurement to obtain measurement information. The detail please refers to relevant art.

In some embodiments, the terminal equipment obtains the CSI according to the measurement information. For example, the terminal equipment obtains the CSI by using an AI/ML module.

FIG. 4 is a schematic diagram of AI/ML module in the terminal equipment. As shown in FIG. 4, for example, some parameters such as channel coefficients h1 and h2, report timing n, predication step d, a predication result of the last time Y (n−1) are inputted into the AI/ML module, and the AI/ML module generates CSI prediction result Y (n+d).

Y (n+d) is transmitted by the terminal equipment at time n as the CSI reporting. That is, the CSI reporting at least indicates a channel state of a second time (n+d) which is later than the first time (n).

It should be appreciated that illustration in FIG. 4 is just an example, the disclosure is also suitable for other type of neural networks with different input information which can realize the purpose of CSI prediction. The details of the neural network, such as structures and parameters please refer to relevant art.

Next some contents about reference signal (RS) are provided for reference.

In NR, a RS report (e.g. CSI report) is configured with RS resources for measurement. The report type may be periodic report, semi-persistent report, or aperiodic report. For different report type, it is configured with different RS type, such as periodic RS, semi persistent RS, aperiodic RS.

Table 1 give an example of CSI report configuration and CSI-RS resource configuration.

TABLE 1
CSI Reporting for possible CSI-RS Configurations

| | Resource Configuration | | |
|---|---|---|---|
| | Report Configuration | | |
| | CSI-RS Configuration | | |
| | Periodic CSI | Semi-Persistent CSI | Aperiodic CSI |
| Periodic | No dynamic | Reporting on PUCCH: | Triggered by DCI, |
| CSI-RS | Triggering or | Triggering by MAC CE | additionally |
| | activation | Reporting on PUSCH: | by MAC CE |
| | | Triggering by DCI | |
| Semi | Not | Reporting on PUCCH: | Triggered by DCI, |
| Persistent | Supported | Triggering by MAC CE | additionally |
| CSI-RS | | Reporting on PUSCH: | by MAC CE |
| | | Triggering by DCI | |
| Aperiodic | Not | Not Supported | Triggered by DCI, |
| CSI-RS | Supported | | additionally |
| | | | by MAC CE |

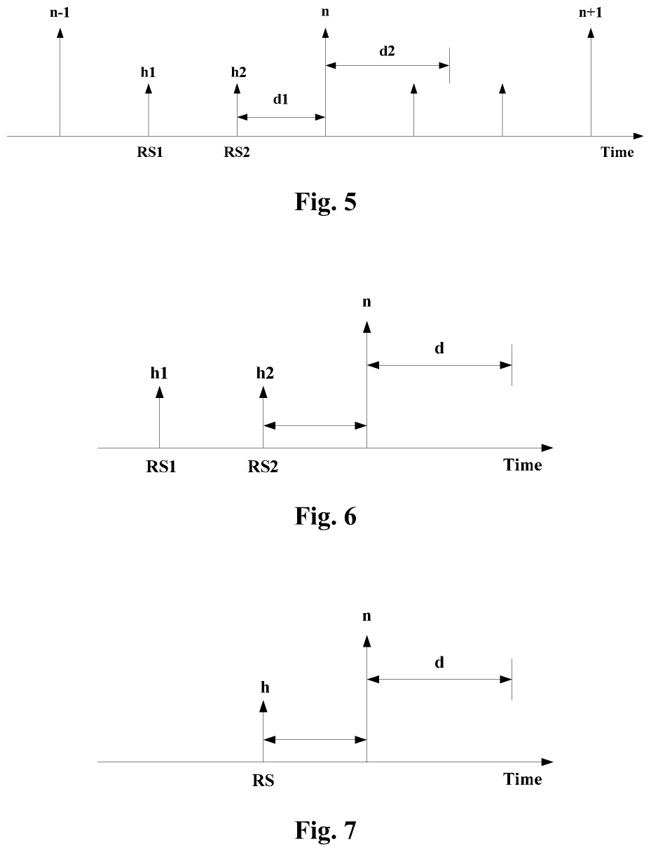

FIG. 5 is a schematic diagram which shows reference signals and a downlink transmission. As shown in FIG. 5, for example, for a periodic CSI report, the CSI report at time instance n is derived by RS1 and RS2. When reporting at time instance n, the estimated CSI is out of date for at least d1+d2. Here, d1 is CSI processing delay in the terminal equipment side (from the time instance of the last RS to n), d2 is a time interval from report timing of n to downlink transmission using the CSI feedback.

In some embodiments, in a training phase of the AI/ML module, a time interval between two RS (such as the interval between RS1 and RS2) and a prediction step (d1+d2, or just d2) are inputted into the AI/ML module. The module is optimized by learning channel knowledge and relationship at these time instances before and after the time instance n. Channel change speed in time domain has big impact on CSI prediction, which is mainly related to the terminal equipment's moving speed relative to its serving base station. A fast-changing channel needs shorter RS interval than that of a slow-changing channel. In addition, the prediction step is closely related to the number of RS and the duration of all RSs for the prediction processing.

After the training phase, for a given prediction step, the AI/ML module have its preferred RS interval (or periodicity) and/or RS number for a channel changing condition. Such kind of relationship is also true for semi persistent CSI-RS.

FIG. 6 is another schematic diagram which shows reference signals and a downlink transmission. As shown in FIG. 6, for example, for an aperiodic CSI report, multiple aperiodic CSI RSs are to be configured and activated to realize a CSI prediction.

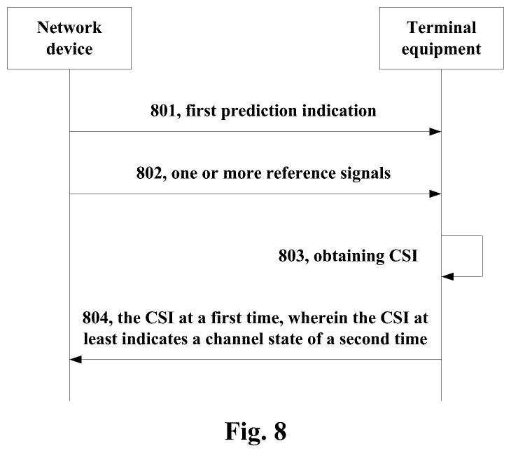

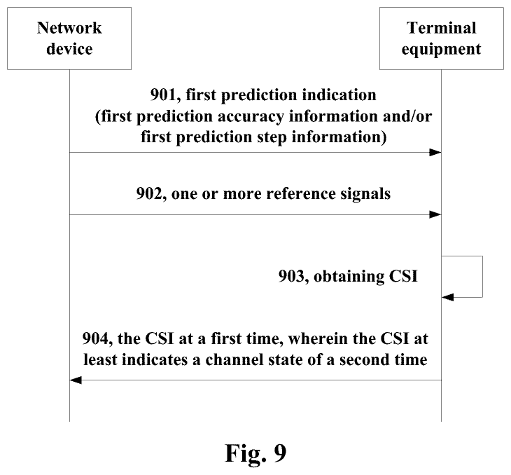

FIG. 7 is another schematic diagram which shows reference signals and a downlink transmission. As shown in FIG. 7, for example, when aperiodic CSI-RS is configured, the CSI prediction is difficult to perform without additional information. The scenario using one RS is possible if the terminal equipment has capability of detecting its moving direction to its serving BS.

For example, the CQI will be increased if a terminal equipment is moving towards to its serving BS, and will be decreased if it is moving away from its serving BS. Nevertheless, multiple aperiodic RS recourses are preferred if can be configured.

FIG. 8 is another schematic diagram which shows a method for reporting CSI in accordance with an embodiment of the present disclosure.

As shown in FIG. 8, the method includes:

801, a terminal equipment receives, from a network device, first prediction indication; wherein the first prediction indication is used to indicate the terminal equipment to predict CSI of the second time.

802, the terminal equipment receives one or more reference signals to obtain measurement information;

803, the terminal equipment obtains CSI according to the measurement information; and

804, the terminal equipment transmits the CSI at a first time according to CSI report configuration, wherein the CSI at least indicates a channel state of a second time which is later than the first time.

It should be appreciated that FIG. 8 is only an example of the disclosure, it is not limited thereto. For example, the order of operations or steps may be adjusted and/or some operations or steps may be omitted. Moreover, some operations or steps not shown in FIG. 8 may be added.

FIG. 9 is another schematic diagram which shows a method for reporting CSI in accordance with an embodiment of the present disclosure.

As shown in FIG. 9, the method includes:

901, a terminal equipment receives, from a network device, first prediction indication; wherein the first prediction indication is used to indicate the terminal equipment to predict CSI of the second time.

As shown in FIG. 9, the terminal equipment may receive, from the network device, first prediction accuracy information for indicating one or more prediction accuracy requirement. For example, the first prediction indication and/or the first prediction accuracy information are/is transmitted via at least one of radio resource control (RRC), media access control (MAC) control element (CE), or downlink control information (DCI). However, it is not limited thereto, for example, the information may be carried via physical downlink shared channel (PDSCH).

As shown in FIG. 9, the terminal equipment may receive, from the network device, first prediction step information which denotes a time interval between the first time and the second time. For example, the first prediction step information is transmitted via at least one of radio resource control (RRC), media access control (MAC) control element (CE), or downlink control information (DCI). However, it is not limited thereto, for example, the information may be carried via physical downlink shared channel (PDSCH).

It should be appreciated that the first prediction accuracy information and/or the first prediction step information may be transmitted together with the first prediction indication, and it is not limited. For example, the first prediction accuracy information and/or the first prediction step information may be transmitted respectively by another message.

902, the terminal equipment receives one or more reference signals to obtain measurement information;

903, the terminal equipment obtains CSI according to the measurement information; and

904, the terminal equipment transmits the CSI at a first time according to CSI report configuration, wherein the CSI at least indicates a channel state of a second time which is later than the first time.

It should be appreciated that FIG. 9 is only an example of the disclosure, it is not limited thereto. For example, the order of operations or steps may be adjusted and/or some operations or steps may be omitted. Moreover, some operations or steps not shown in FIG. 9 may be added.

In some embodiments, the first prediction step information is scaled based on subcarrier spacing (SCS). From processing time perspective, prediction step is closely related to processing delay in the terminal equipment side and the network device side.

On the other hand, the prediction step supported by the AI/ML module also depending on coherent time of a wireless channel. For example, the coherent time is expressed as: Ct=1/fd, fd is a doppler shift.

The prediction step d is linearly related to the coherent time. d=a Ct. For example, the d is scaled with SCS as shown in this table 2, if d is estimated as 1 ms. For other d value, it can be derived accordingly.

TABLE 2

| | 15 kHz | 30 kHz | 60 kHz | 120 kHz | 120 kHz |
|---|---|---|---|---|---|
| d = 1 ms | 1 slot | 2 slot | 4 slot | 8 slot | 8 slot |

The terminal equipment may exchange its prediction capability with the network device, a better performance can be achieved if the CSI delay of the terminal equipment side and the network device side can match to the prediction step of the UE capability. (via AI/ML module, e.g.)

In some embodiments, the terminal equipment transmits, to the network device, a request for indicating at least one of reference signal periodicity, reference signal interval, reference signal number, or mobility indication.

The reference signal periodicity or mobility indication is used by the network device to determine periodic configuration or semi-persistent configuration of the one or more reference signals; the reference signal interval or reference signal number or mobility indication is used by the network device to determine number and/or positions of aperiodic reference signals.

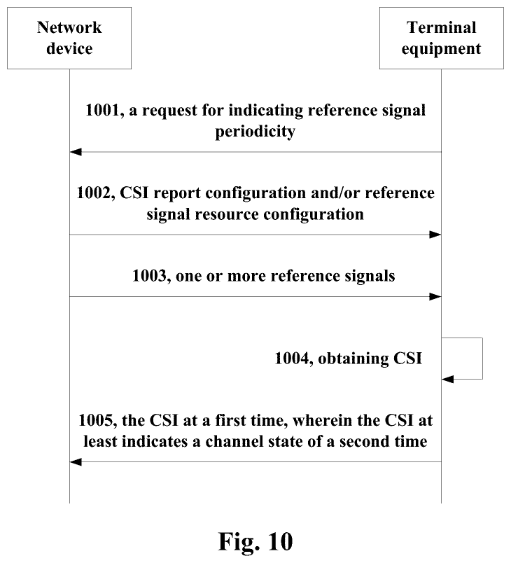

FIG. 10 is another schematic diagram which shows a method for reporting CSI in accordance with an embodiment of the present disclosure.

As shown in FIG. 10, the method includes:

1001, the terminal equipment transmits a request for indicating reference signal periodicity.

For example, the terminal equipment selects a preferred RS periodicity for its AI/ML module for CSI prediction. The terminal equipment transmits a RS periodicity request to the network device side accordingly. The preferred RS periodicity may be derived according to estimated channel change speed. Besides, the preferred RS periodicity may be related to prediction step and input/output signal features of the AI/ML module in the training phase.

For example, the terminal equipment may transmit its mobility indication directly to the network device, based on the estimated channel change speed or estimated Doppler shift information. The network device side derives the reference signal periodicity accordingly. The mobility indication can be indicated via several bits for a relative level or an absolute channel changing metric.

1002, the terminal equipment receives CSI report configuration and/or reference signal resource configuration.

For example, the terminal equipment may be already configured with one or more CSI report configuration and one or more CSI-RS resource configuration. If multiple periodic or semi persistent CSI-RS resource are configured, the terminal equipment may send a preferred RS periodicity request to the network device side in 1001. In 1002, it is also possible that CSI report configuration and/or RS resource configuration are transmitted to the terminal equipment side after the RS periodicity request.

1003, the terminal equipment receives one or more reference signals to obtain measurement information.

1004, the terminal equipment obtains CSI according to the measurement information.

For example, CSI-RS based on the RS periodicity request may be transmitted from the network device side. The terminal equipment side may select one or more measurement result as the input of the AI/ML module. The AI/ML module generates the predicted CSI for time n+d.

1005, the terminal equipment transmits the CSI at a first time according to CSI report configuration, wherein the CSI at least indicates a channel state of a second time which is later than the first time.

It should be appreciated that FIG. 10 is only an example of the disclosure, it is not limited thereto. For example, the order of operations or steps may be adjusted and/or some operations or steps may be omitted. Moreover, some operations or steps not shown in FIG. 10 may be added.

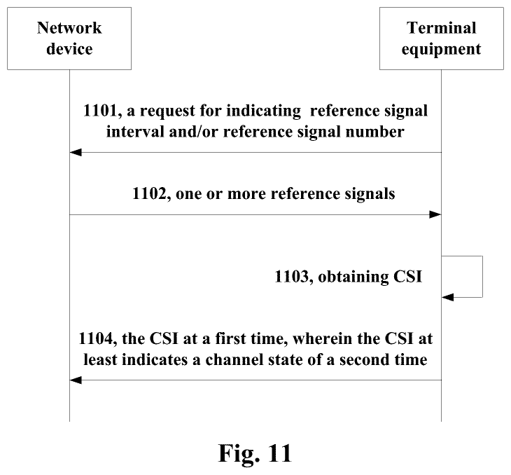

FIG. 11 is another schematic diagram which shows a method for reporting CSI in accordance with an embodiment of the present disclosure.

As shown in FIG. 11, the method includes:

1101, the terminal equipment transmits a request for indicating reference signal interval and/or reference signal number.

For example, for a procedure of aperiodic CSI report or semi persistent CSI report configuration and activation, the terminal equipment may transmit a RS interval request to the network device side, and ask the network device configure/schedule one or more aperiodic RSs with the preferred RS interval. Alternatively, the number of RSs may be transmitted to the network device side as well. The CSI-RS pattern also can be realized by semi-persistent CSI-RS as well, with the periodicity of the RS interval and the activation/deactivation to control the of RS number.

For example, the terminal equipment may transmit its mobility indication directly to the network device, based on the estimated channel change speed or estimated Doppler shift information. The network device side derives the RS interval and/or the number of RSs for an aperiodic CSI report configuration and its CSI resource configuration.

1102, the terminal equipment receives one or more reference signals to obtain measurement information.

1103, the terminal equipment obtains CSI according to the measurement information.

For example, CSI-RS based on the RS interval request and/or RS number request may be transmitted from the network device side. The terminal equipment side may select one or more measurement result as the input of the AI/ML module. The AI/ML module generates the predicted CSI for time n+d.

1104, the terminal equipment transmits the CSI at a first time according to CSI report configuration, wherein the CSI at least indicates a channel state of a second time which is later than the first time.

It should be appreciated that FIG. 11 is only an example of the disclosure, it is not limited thereto. For example, the order of operations or steps may be adjusted and/or some operations or steps may be omitted. Moreover, some operations or steps not shown in FIG. 11 may be added.

In some embodiments, the terminal equipment determines CSI prediction is not supported.

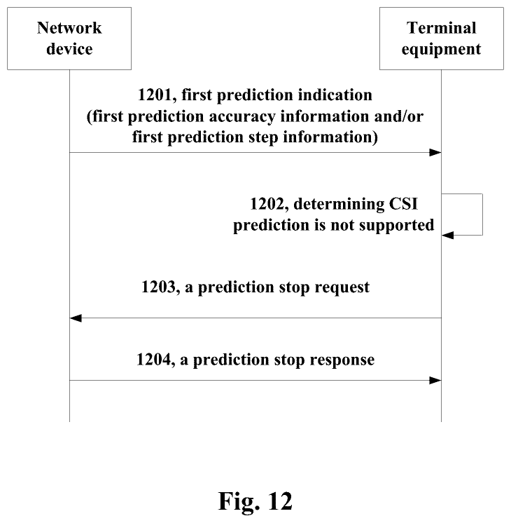

FIG. 12 is another schematic diagram which shows a method for reporting CSI in accordance with an embodiment of the present disclosure.

As shown in FIG. 12, the method includes:

1201, a terminal equipment receives, from a network device, first prediction indication; wherein the first prediction indication is used to indicate the terminal equipment to predict CSI of the second time.

As shown in FIG. 12, the terminal equipment may receive, from the network device, first prediction accuracy information and/or first prediction step information. It should be appreciated that the first prediction accuracy information and/or the first prediction step information may be transmitted together with the first prediction indication, and it is not limited. For example, the first prediction accuracy information and/or the first prediction step information may be transmitted respectively by another message.

1202, the terminal equipment determines CSI prediction is not supported;

1203, the terminal equipment transmits a prediction stop request; and

1204, the terminal equipment receives a prediction stop response.

It should be appreciated that FIG. 12 is only an example of the disclosure, it is not limited thereto. For example, the order of operations or steps may be adjusted and/or some operations or steps may be omitted. Moreover, some operations or steps not shown in FIG. 12 may be added.

For example, upon receiving prediction indication (perhaps including prediction step and/or prediction accuracy), the terminal equipment may judge its prediction performance is not good enough, the terminal equipment transmits a prediction stop request to the network device; the network device sends a prediction stop response then.

For example, the reason that the terminal equipment decides to stop prediction may be the following one or more issues: channel is changed too fast, the prediction cannot have accurate estimation for a given prediction step; channel is changed too fast, the prediction cannot have accurate estimation for the given prediction step and configured RS periodicity; the given prediction step and the configured RS periodicity cannot match the channel change; the prediction accuracy cannot be met.

In some embodiments, the network device determines CSI prediction is not supported.

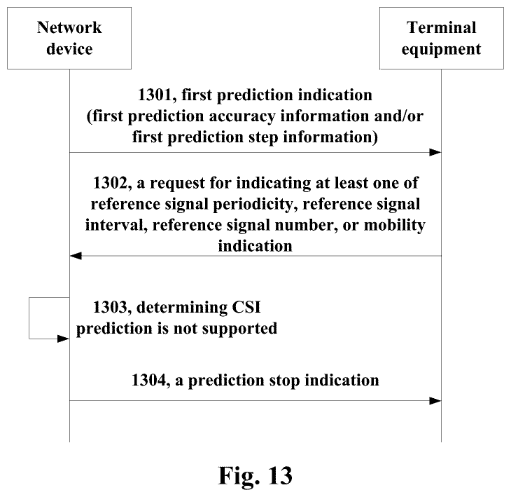

FIG. 13 is another schematic diagram which shows a method for reporting CSI in accordance with an embodiment of the present disclosure.

As shown in FIG. 13, the method includes:

1301, a terminal equipment receives, from a network device, first prediction indication; wherein the first prediction indication is used to indicate the terminal equipment to predict CSI of the second time.

As shown in FIG. 13, the terminal equipment may receive, from the network device, first prediction accuracy information and/or first prediction step information. It should be appreciated that the first prediction accuracy information and/or the first prediction step information may be transmitted together with the first prediction indication, and it is not limited. For example, the first prediction accuracy information and/or the first prediction step information may be transmitted respectively by another message.

1302, the terminal equipment transmits a request for indicating at least one of reference signal periodicity, reference signal interval, reference signal number, or mobility indication.

1303, the network device determines CSI prediction is not supported.

1304, the network device transmits a prediction stop indication.

It should be appreciated that FIG. 13 is only an example of the disclosure, it is not limited thereto. For example, the order of operations or steps may be adjusted and/or some operations or steps may be omitted. Moreover, some operations or steps not shown in FIG. 13 may be added.

For example, when receiving a RS interval request from the terminal equipment, the network device may not be able to schedule and transmit the RS according to the RS interval request. Then, the network device sends the prediction stop indication to the terminal equipment. The terminal equipment will not perform CSI prediction after receiving the stop indication.

Besides this example, after the network device indicating the terminal equipment to perform CSI prediction, the network device may directly indicate the terminal equipment to stop CSI prediction when judging there is a necessity.

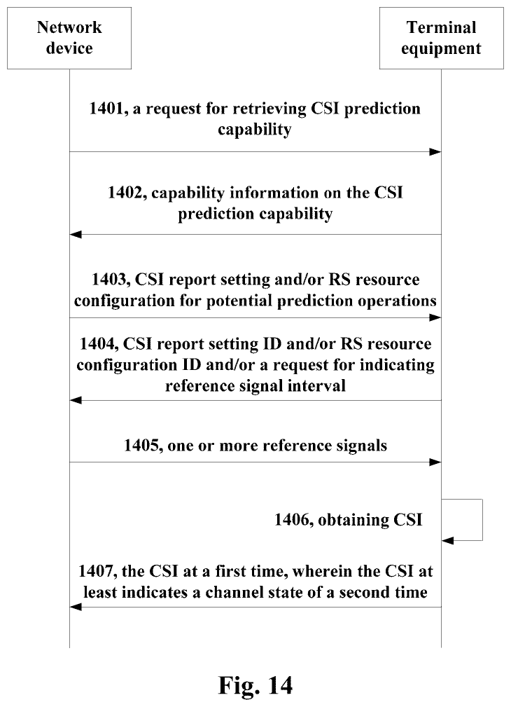

FIG. 14 is another schematic diagram which shows a method for reporting CSI in accordance with an embodiment of the present disclosure.

As shown in FIG. 14, the method includes:

1401, the terminal equipment receives, from the network device, a request for retrieving CSI prediction capability; and

1402, the terminal equipment reports, to the network device, capability information on the CSI prediction capability.

For example, the network device initiates a CSI prediction capability inquiry to the terminal equipment, and the terminal equipment reports whether supporting prediction or not. Besides, the terminal equipment may report RS periodicity or RS interval, number of RS, RS duration information for potential prediction operations. The relationship between the prediction step and related RS interval may be predefined or exchanged between the terminal equipment and the network device in this capability inquiry/response procedure.

1403, the network device configures one or more CSI report settings and one or more RS resource configurations for potential prediction operations.

1404, the terminal equipment transmits CSI report setting ID and/or RS resource configuration ID and/or a request for indicating reference signal interval.

For example, based on capability information, the network device configures one or more CSI report setting with possible RS resource configurations (including different RS periodicities or RS intervals) to the terminal equipment side. The terminal equipment may send a RS interval request or a CSI report ID or a RS resource configuration ID which is suitable for a given prediction step according to its capability (AI/ML e.g.).

1405, the terminal equipment receives one or more reference signals to obtain measurement information.

1406, the terminal equipment obtains CSI according to the measurement information.

1407, the terminal equipment transmits the CSI at a first time according to CSI report configuration, wherein the CSI at least indicates a channel state of a second time which is later than the first time.

It should be appreciated that FIG. 14 is only an example of the disclosure, it is not limited thereto. For example, the order of operations or steps may be adjusted and/or some operations or steps may be omitted. Moreover, some operations or steps not shown in FIG. 14 may be added.

In some embodiments, the prediction is initiated by the terminal equipment.

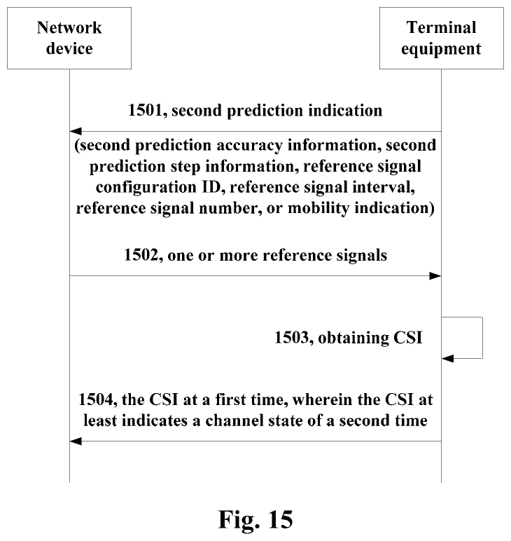

FIG. 15 is another schematic diagram which shows a method for reporting CSI in accordance with an embodiment of the present disclosure.

As shown in FIG. 15, the method includes:

1501, the terminal equipment transmits, to a network device, second prediction indication or prediction request; wherein the second prediction indication is used to indicate that the terminal equipment is to predict CSI of the second time.

As shown in FIG. 15, the terminal equipment may transmit, to the network device, at least one of second prediction accuracy information, second prediction step information, reference signal configuration ID, reference signal interval, or reference signal number or mobility indication, or prediction request. It should be appreciated that the information may be transmitted together with the second prediction indication, and it is not limited. For example, the information may be transmitted respectively by another message.

For example, the terminal equipment detects its channel change speed is very fast and there is a necessity to do CSI prediction, and then transmit a prediction request or indication to the network device. Alternatively, the terminal equipment can transmit a mobility indication to the network device with the similar function of CSI prediction indication.

1502, the terminal equipment receives one or more reference signals to obtain measurement information.

For example, reference signal resource configuration is determined by the network device according to at least one of the second prediction accuracy information, the second prediction step information, reference signal configuration ID, reference signal interval, reference signal number, or mobility indication.

1503, the terminal equipment obtains CSI according to the measurement information.

1504, the terminal equipment transmits the CSI at a first time according to CSI report configuration, wherein the CSI at least indicates a channel state of a second time which is later than the first time.

It should be appreciated that FIG. 15 is only an example of the disclosure, it is not limited thereto. For example, the order of operations or steps may be adjusted and/or some operations or steps may be omitted. Moreover, some operations or steps not shown in FIG. 15 may be added.

The above embodiments are illustrated by using prediction information, and it is not limited thereto. For example, reliability information and/or delay information may be used in this disclosure.

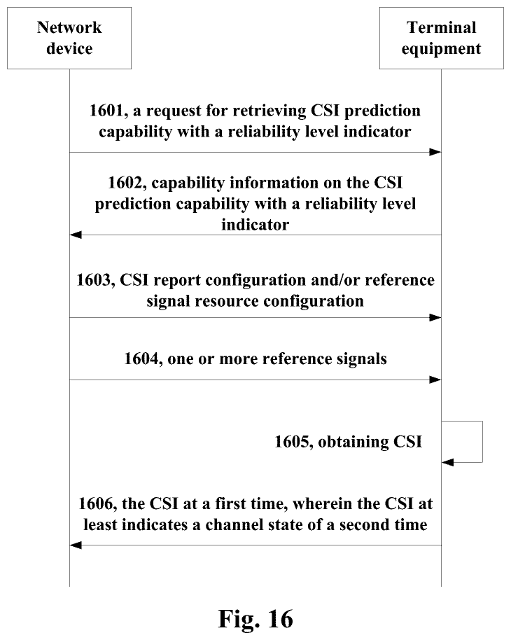

FIG. 16 is another schematic diagram which shows a method for reporting CSI in accordance with an embodiment of the present disclosure.

As shown in FIG. 16, the method includes:

1601, the terminal equipment receives, from the network device, a request for retrieving CSI report capability with a reliability level indicator.

For example, the CQI table index in the CSI report or CSI report configuration can indicate whether high reliability is requested, and can be as the indication of QoS. Here, the CQI table can be either ‘table1’, ‘table2’, ‘table3’ according to 3GPP TS 38.214 V16.7.0. It should be appreciated that these 3 CQI tables is only an example of the disclosure, it is not limited thereto.

1602, the terminal equipment reports, to the network device, capability information on the CSI report capability with a reliability level indicator. In this example, the prediction step and corresponding RS interval (range) for a QoS indication can be predetermined and thus being known in both network device and terminal equipment.

1603, the terminal equipment receives, from the network device, the CSI report configurations and/or reference signal resource configurations, wherein CSI delay information is comprised in the CSI report configuration.

1604, the terminal equipment receives one or more reference signals to obtain measurement information.

1605, the terminal equipment obtains CSI according to the measurement information.

1606, the terminal equipment transmits the CSI at a first time according to CSI report configuration, wherein the CSI at least indicates a channel state of a second time which is later than the first time.

It should be appreciated that FIG. 16 is only an example of the disclosure, it is not limited thereto. For example, the order of operations or steps may be adjusted and/or some operations or steps may be omitted. Moreover, some operations or steps not shown in FIG. 16 may be added.

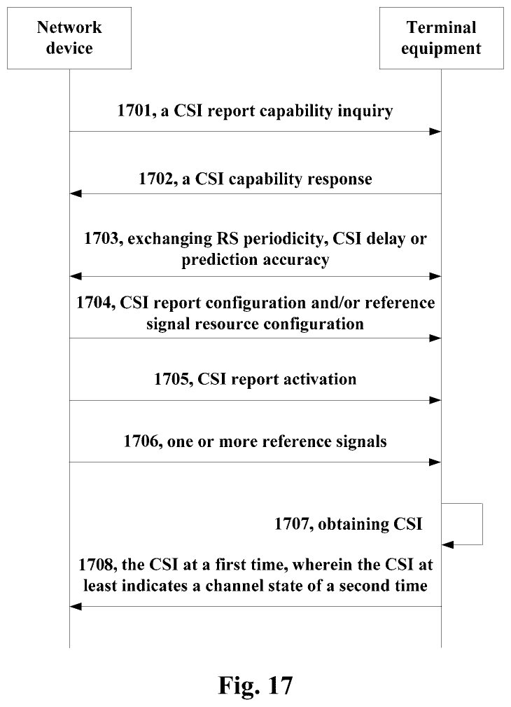

FIG. 17 is another schematic diagram which shows a method for reporting CSI in accordance with an embodiment of the present disclosure.

As shown in FIG. 17, the method includes:

1701, the terminal equipment receives, from the network device, a CSI report capability inquiry.

1702, the terminal equipment reports, to the network device, a CSI capability response.

1703, the terminal equipment and the network device exchange RS periodicity, CSI delay or prediction accuracy.

1704, the terminal equipment receives, from the network device, one or more CSI report configurations and/or one or more reference signal resource configurations.

1705, the network device activates to trigger periodic CSI report through CSI report configuration directly, and/or trigger semi-persistent CSI report through MAC CE or DCI, and/or trigger aperiodic CSI report through DCI. In these activating CSI reports, QoS indication (a reliability level indicator) for high reliability may be included;

1706, the terminal equipment receives one or more reference signals to obtain measurement information accordingly.

1707, the terminal equipment obtains CSI according to the measurement information.

1708, the terminal equipment transmits the CSI at a first time according to CSI report configuration, wherein the CSI at least indicates a channel state of a second time which is later than the first time.

It should be appreciated that FIG. 17 is only an example of the disclosure, it is not limited thereto. For example, the order of operations or steps may be adjusted and/or some operations or steps may be omitted. Moreover, some operations or steps not shown in FIG. 17 may be added.

For example, high reliability is a key request for some applications. It is very sensitive to the performance degradation caused by CSI delay. Even, such kind of performance loss should be avoided to guarantee the reliability request.

As shown in FIG. 17, the CSI delay or prediction step is exchanged between the network device and the terminal equipment; the CSI prediction capability, or high reliability endurance is exchanged between the network device and the terminal equipment. Accordingly, the network device has some knowledge on RS periodicity needed for the high reliability, or it is based on terminal equipment's request still. The network device activates or schedules a CSI report with QoS request, such as reliability indicator, and the terminal equipment obtains CSI and reports it to the network device.

In this procedure, the terminal equipment knows the potential CSI delay, which is the delay from the time instance of the CSI reporting to the downlink data transmission using this CSI. The processing delay for calculate CSI at terminal equipment side will be treated by the terminal equipment itself. The network device may initiate CSI prediction capability or high reliability inquiry to the terminal equipment. The terminal equipment will feedback its capability accordingly.

During the inquiry procedure, the network device gets information of terminal equipment's CSI prediction capability or high reliability endurance capability, and the terminal equipment gets information of CSI delay; the network device may get necessary RS periodicity (or RS interval) for the high reliability.

The above information exchange also is performed before the high reliability traffic via request and response procedure. The network device transmits CSI report configuration or activation (via MAC CE or DCI) to the terminal equipment, to ask the terminal equipment performs relevant CSI reporting (periodic, semi-persistent, aperiodic). Together, with a QoS indication to indicate its high reliability request.

Upon receiving the information, the terminal equipment obtains the CSI with the consideration of CSI delay and the QoS request (reliability level indication or indicator, e.g.). The terminal equipment reports the CSI at the schedule report timing. Hereby, a default operation of the terminal equipment is to guarantee the QoS (high reliability e.g.) of the next downlink transmission, and CSI prediction becomes an operation depending on UE's implementation or capability.

In the processing of obtaining CSI, the terminal equipment may use its AI/ML module to perform CSI measurement and prediction, based on QoS level request (reliability level, e.g.), CSI delay or prediction step, RS interval and the number of RS.

One example of the reliability level or indication is referring to the CQI table index in the CSI report or CSI report configuration. The CQI table can be either ‘table1’, ‘table2’, ‘table3’ according to 3GPP TS 38.214 V16.7.0. It should be appreciated that these three CQI tables is only an example of the disclosure, it is not limited thereto.

In the procedure of UE capability inquiry, AI/ML for CSI measurement may be inquired and reported. In the CSI report configurations of 1704, information of AI/ML module being enabled may be included in the configurations. Through a specific configuration with CSI measurement via AI/ML enabling, the terminal equipment will use its AI/ML to process CSI measurement, and/or to perform CSI prediction according to its judgement.

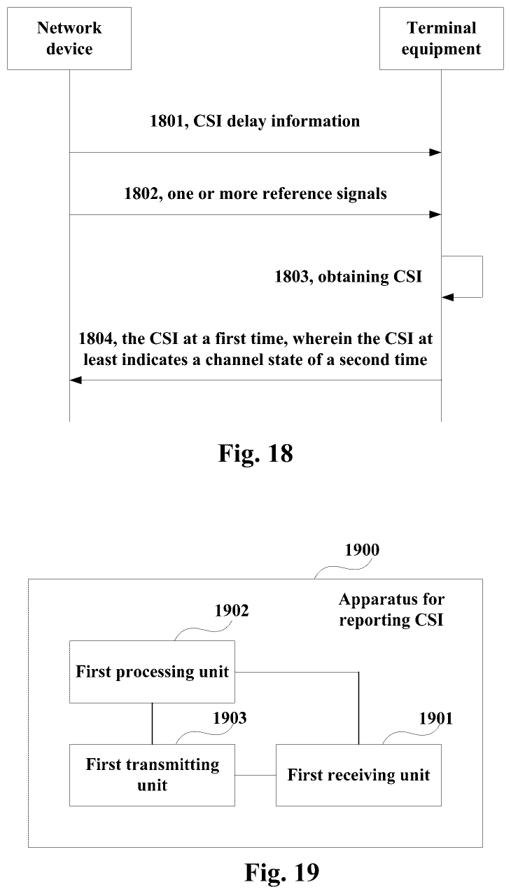

FIG. 18 is another schematic diagram which shows a method for reporting CSI in accordance with an embodiment of the present disclosure.

As shown in FIG. 18, the method includes:

1801, the terminal equipment receives, from the network device, CSI delay information; wherein the CSI delay information is used to indicate the terminal equipment to obtain CSI of the second time.

1802, the terminal equipment receives one or more reference signals to obtain measurement information.

1803, the terminal equipment obtains CSI according to the measurement information.

1804, the terminal equipment transmits the CSI at a first time according to CSI report configuration, wherein the CSI at least indicates a channel state of a second time which is later than the first time.

It should be appreciated that FIG. 18 is only an example of the disclosure, it is not limited thereto. For example, the order of operations or steps may be adjusted and/or some operations or steps may be omitted. Moreover, some operations or steps not shown in FIG. 18 may be added.

For example, the terminal equipment always performs CSI reporting with its prediction functions, for a given CSI delay information. The network device provides a CSI delay information in CSI report configuration or in other way. In the CSI reporting capability inquiry and response procedure, the terminal equipment reports its CSI reporting with prediction result capability.

For example, there are CSI report capability inquiry procedure and/or CSI reporting configure procedure; the terminal equipment may get the CSI delay information through the configuration. AI/ML capability of the terminal equipment may be known by the network device. Thus, CSI delay information may be enough to the AI/ML module to generate accurate CSI report.

In every CSI reporting, the prediction result is applied. In the processing of obtaining CSI, the terminal equipment may use its AI/ML module to perform CSI measurement, based on CSI delay or prediction step. CSI prediction becomes a default operation of the AI/ML module.

In some embodiments, differential CSI is used to indicates the channel state of the second time.

For example, the terminal equipment may first estimate CSI for time instance n, and then predict a differential CSI for the time instance n+d. For example, n is a CSI reporting time instance, d is delay time from time instance n to time instance of downlink transmission using the CSI feedback.

In this way, for example, the terminal equipment reports CSI with the following format: CSI@n+differential CSI for n+d. The bit number of part 1 (CSI@n) is the same as that of related CSI report; the bit number of part 2 is the differential CSI for the prediction step d.

For example, if the CSI quality is CQI, using 5-bit for feedback. In the above format, part 1 use 5-bit for CQI, part 2 may use 1 or 2 bit to indicate the prediction result. This way also can apply to other CSI quality metrics, such as precoding matrix indicator (PMI), CSI-RS resource indicator (CRI), SS/PBCH Block Resource indicator (SSBRI), layer indicator (LI), rank indicator (RI), L1-RSRP or L1-SINR.

In this example, the network device side may decide to whether use CSI@n or use CSI@n+Differential CSI@n+d based on prediction accuracy, if the prediction accuracy is provided by the terminal equipment, or the network device may judge it by using other feedback, or qualities of other signals.

The other possibility is that the network device may decide to whether use CSI@n or use CSI@n+Differential CSI@n+d based on QoS level, the QoS level is used for the data being transmitted at time instance n+d.

In an additional example, part 1 may be reported at a report timing without prediction, and part 2 may be reported in the following report timing with prediction.

It is also possible that the terminal equipment directly uses the predicted CSI and uses the same format in the CSI report. In the example, upon receiving the CSI report, the network device may use the report for data transmission at time instance n+d.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

As can be seen from the above embodiments, a terminal equipment receives one or more reference signals to obtain measurement information; obtains CSI according to the measurement information; and transmits the CSI at a first time according to CSI report configuration, wherein the CSI at least indicates a channel state of a second time which is later than the first time. Therefore, the network device side can obtain accuracy CSI for downlink transmission.

### Second Aspect of Embodiments

An apparatus for reporting CSI is provided in the disclosure. The apparatus may be the terminal equipment 102 or may be configured in the terminal equipment 102, and the same contents as those in the first aspect of embodiments are omitted.

FIG. 19 shows a block diagram of an apparatus 1900 in accordance with an embodiment of the present disclosure.

As shown in FIG. 19, the apparatus 1900 includes: a first receiving unit 1901, a first processing unit 1902 and a first transmitting unit 1903. The first receiving unit 1901 is configured to receive one or more reference signals to obtain measurement information; the first processing unit 1902 is configured to obtain CSI according to the measurement information; and the first transmitting unit 1903 is configured to transmit the CSI at a first time according to CSI report configuration, wherein the CSI at least indicates a channel state of a second time which is later than the first time.

In some embodiments, the first receiving unit 1901 is configured to receive, from a network device, at least one of first prediction indication, first prediction accuracy information or first prediction step information.

In some embodiments, the first prediction indication is used to indicate the terminal equipment to predict CSI of the second time; the first prediction accuracy information is used for indicating one or more prediction accuracy requirement; the first prediction step information is used to denote a time interval between the first time and the second time.

In some embodiments, the first prediction indication and/or the first prediction accuracy information are/is transmitted via at least one of radio resource control (RRC), media access control (MAC) control element (CE), or downlink control information (DCI).

In some embodiments, the first prediction step information is scaled based on subcarrier spacing (SCS).

In some embodiments, the first prediction step information is transmitted via at least one of radio resource control (RRC), media access control (MAC) control element (CE), or downlink control information (DCI).

In some embodiments, the first transmitting unit 1903 is configured to transmit, to a network device, a request for indicating at least one of reference signal periodicity, reference signal interval, reference signal number, or mobility indication.

In some embodiments, the reference signal periodicity is used by the network device to determine periodic configuration or semi-persistent configuration of the one or more reference signals.

In some embodiments, the reference signal interval or reference signal number or mobility indication is used by the network device to determine semi-persistent configuration or aperiodic configuration of the one or more reference signals.

In some embodiments, the first receiving unit 1901 is configured to receive, from a network device, the CSI report configuration and/or reference signal resource configuration.

In some embodiments, at least one of first prediction indication, first prediction accuracy information or first prediction step information are comprised in the CSI report configuration;

In some embodiments, the reference signal resource configuration is determined by the network device according to at least one of reference signal periodicity, reference signal interval, reference signal number, or mobility indication.

In some embodiments, the first processing unit 1902 is configured to determine CSI prediction is not supported; the first transmitting unit 1903 is configured to transmit a prediction stop request; and the first receiving unit 1901 is configured to receive a prediction stop response.

In some embodiments, the first receiving unit 1901 is configured to receive a prediction stop indication.

In some embodiments, the first receiving unit 1901 is configured to receive a request for retrieving CSI prediction capability; and the transmitting unit is configured to report capability information on the CSI prediction capability.

In some embodiments, the first transmitting unit 1903 is configured to transmit second prediction indication; wherein the second prediction indication is used to indicate that the terminal equipment is to predict CSI of the second time.

In some embodiments, the first transmitting unit 1903 is configured to transmit at least one of second prediction accuracy information, second prediction step information, reference signal configuration ID, reference signal interval, reference signal number, or mobility indication.

In some embodiments, reference signal resource configuration is determined by the network device according to at least one of the second prediction accuracy information, the second prediction step information, reference signal configuration ID, reference signal interval, reference signal number, or mobility indication.

In some embodiments, the first receiving unit 1901 is configured to receive reliability level indication; wherein the reliability level indication is used to indicate the terminal equipment to obtain CSI for data transmission at the second time being able to match the request of the reliability level.

In some embodiments, the first receiving unit 1901 is configured to receive a request for retrieving CSI report capability with a reliability level indicator; and the first transmitting unit 1903 is configured to report capability information on the CSI report capability with a reliability level indicator.

In some embodiments, the first receiving unit 1901 is configured to receive the CSI report configuration and/or reference signal resource configuration, wherein CSI delay information is comprised in the CSI report configuration.

In some embodiments, the first receiving unit 1901 is configured to receive CSI delay information; wherein the CSI delay information is used to indicate the terminal equipment to obtain CSI of the second time.

In some embodiments, differential CSI is used to indicates the channel state of the second time.

An apparatus for receiving CSI is provided in this disclosure. The apparatus may be the network device 101 or may be configured in the network device 101, and the same contents as those in the first aspect of embodiments are omitted.

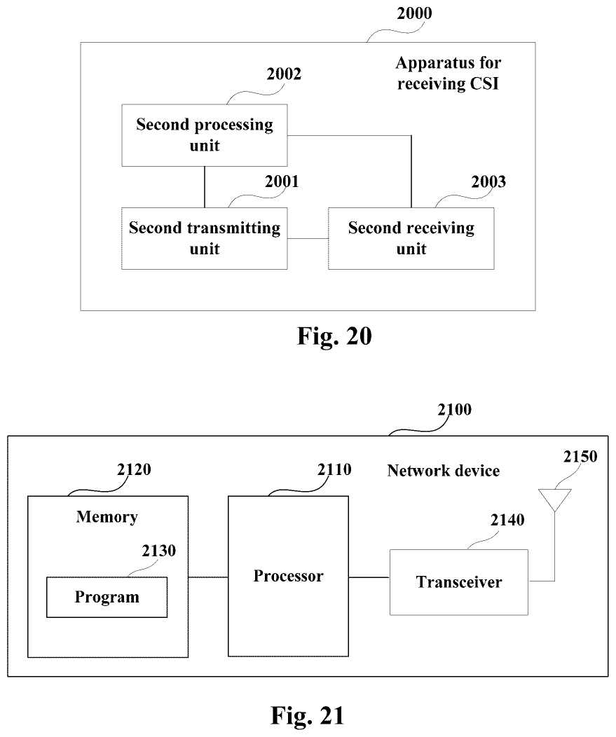

FIG. 20 shows a block diagram of an apparatus 2000 in accordance with an embodiment of the present disclosure.

As shown in FIG. 20, the apparatus 2000 includes: a second transmitting unit 2001, a second processing unit 2002 and a second receiving unit 2003. The second transmitting unit 2001 is configured to transmit one or more reference signals according to reference signal resource configuration; and the second receiving unit 2003 is configured to receive CSI at a first time, wherein the CSI at least indicates a channel state of a second time which is later than the first time.

In some embodiments, the second transmitting unit 2001 is configured to transmit, to a terminal equipment, at least one of first prediction indication, first prediction accuracy information or first prediction step information.

In some embodiments, the first prediction indication is used to indicate the terminal equipment to predict CSI of the second time; the first prediction accuracy information is used for indicating one or more prediction accuracy requirement; the first prediction step information is used to denote a time interval between the first time and the second time.

In some embodiments, the first prediction indication and/or the first prediction accuracy information are/is transmitted via at least one of radio resource control (RRC), media access control (MAC) control element (CE), or downlink control information (DCI).

In some embodiments, the first prediction step information is scaled based on subcarrier spacing (SCS).

In some embodiments, the first prediction step information is transmitted via at least one of radio resource control (RRC), media access control (MAC) control element (CE), or downlink control information (DCI).

In some embodiments, the second receiving unit 2003 is configured to receive, from the terminal equipment, a request for indicating at least one of reference signal periodicity, reference signal interval reference signal number, or mobility indication.

In some embodiments, the reference signal periodicity is used by the network device to determine periodic configuration or semi-persistent configuration of the one or more reference signals.

In some embodiments, the reference signal interval or reference signal number or mobility indication is used by the network device to determine semi-persistent configuration or aperiodic configuration of the one or more reference signals.

In some embodiments, the second transmitting unit 2001 is configured to transmit, to the terminal equipment, the CSI report configuration and/or reference signal resource configuration.

In some embodiments, at least one of first prediction indication, first prediction accuracy information or first prediction step information is/are comprised in the CSI report configuration.

In some embodiments, the reference signal resource configuration is determined by the network device according to at least one of reference signal periodicity, reference signal interval, reference signal number, or mobility indication.

In some embodiments, the second receiving unit 2003 is configured to receive a prediction stop request; and the second transmitting unit 2001 is configured to transmit a prediction stop response.

In some embodiments, the second processing unit 2002 is configured to determine CSI prediction is not supported; the second transmitting unit 2001 is configured to transmit a prediction stop indication.

In some embodiments, the second transmitting unit 2001 is configured to transmit a request for retrieving CSI prediction capability; and the second receiving unit 2003 is configured to receive capability information on the CSI prediction capability.

In some embodiments, the second processing unit 2002 is configured to receive second prediction indication; wherein the second prediction indication is used to indicate that the terminal equipment is to predict CSI of the second time.

In some embodiments, the second processing unit 2002 is configured to receive at least one of second prediction accuracy information, second prediction step information, reference signal configuration ID, reference signal interval, reference signal number, or mobility indication.

In some embodiments, reference signal resource configuration is determined by the network device according to at least one of the second prediction accuracy information, the second prediction step information, reference signal configuration ID, reference signal interval, reference signal number, or mobility indication.

In some embodiments, the second transmitting unit 2001 is configured to transmit reliability level indication; wherein the reliability level indication is used to indicate the terminal equipment to obtain CSI for data transmission at the second time being able to match the request of the reliability level.

In some embodiments, the second transmitting unit 2001 is configured to transmit a request for retrieving CSI report capability with a reliability level indicator; and the second receiving unit 2003 is configured to receive capability information on the CSI report capability with a reliability level indicator.

In some embodiments, the second transmitting unit 2001 is configured to transmit the CSI report configuration and/or reference signal resource configuration, wherein CSI delay information is comprised in the CSI report configuration.

In some embodiments, the second transmitting unit 2001 is configured to transmit CSI delay information; wherein the CSI delay information is used to indicate the terminal equipment to obtain CSI of the second time.

In some embodiments, differential CSI is used to indicates the channel state of the second time.

It should be appreciated that components included in the apparatus 1900 or 2000 correspond to the operations of the above methods. Therefore, all operations and features described above with reference to above figures are likewise applicable to the components included in the apparatus 1900 or 2000 and have similar effects. For the purpose of simplification, the details will be omitted.

It should be appreciated that the components included in the apparatus 1900 or 2000 may be implemented in various manners, including software, hardware, firmware, or any combination thereof.

In an embodiment, one or more units may be implemented using software and/or firmware, for example, machine-executable instructions stored on the storage medium. In addition to or instead of machine-executable instructions, parts or all of the components included in the apparatus 1900 or 2000 may be implemented, at least in part, by one or more hardware logic components.

For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

The apparatus 1900 or 2000 may be a part of a device. But it is not limited thereto, for example, the apparatus 1900 may be the terminal equipment 102, other parts of the terminal equipment 102, such as transmitter and receiver, are omitted in FIG. 19. For another example, the apparatus 2000 may be the network device 101, other parts of the network device 101, such as transmitter and receiver, are omitted in FIG. 20.

As can be seen from the above embodiments, a terminal equipment receives one or more reference signals to obtain measurement information; obtains CSI according to the measurement information; and transmits the CSI at a first time according to CSI report configuration, wherein the CSI at least indicates a channel state of a second time which is later than the first time. Therefore, the network device side can obtain accuracy CSI for downlink transmission.

### Third Aspect of Embodiments

The embodiments of this disclosure provide a communication system, and reference may be made to FIG. 1, with contents identical to those in the embodiments of the first aspect being not going to be described herein any further.

In some embodiments, the communication system 100 may include:

a terminal equipment 102 configured to receive one or more reference signals to obtain measurement information; obtain CSI according to the measurement information; and transmit the CSI at a first time according to CSI report configuration; and

a network device 101 configured to transmit one or more reference signals according to reference signal resource configuration; and receive the CSI at the first time; wherein the CSI at least indicates a channel state of a second time which is later than the first time.

The embodiment of this disclosure further provides a network device, which may be, for example, a base station. However, this disclosure is not limited thereto, and it may also be another network device.

FIG. 21 is a schematic diagram of the network device of the embodiment of this disclosure. As shown in FIG. 21, the network device 2100 may include a processor 2110 (such as a central processing unit (CPU)) and a memory 2120, the memory 2120 being coupled to the processor 2110. The memory 2120 may store various data, and furthermore, it may store a program 2130 for data processing, and execute the program 2130 under control of the processor 2110.

For example, the processor 2110 may be configured to execute the program to carry out the method as described in the first aspect of embodiments. For example, the processor 2110 may be configured to execute the following control: transmitting one or more reference signals according to reference signal resource configuration; and receiving CSI at a first time, wherein the CSI at least indicates a channel state of a second time which is later than the first time.

Furthermore, as shown in FIG. 21, the network device 2100 may include a transceiver 2140, and an antenna 2150, etc. Functions of the above components are similar to those in the related art, and shall not be described herein any further. It should be noted that the network device 2100 does not necessarily include all the parts shown in FIG. 21, and furthermore, the network device 2100 may include parts not shown in FIG. 21, and the related art may be referred to.

The embodiment of this disclosure further provides a terminal equipment; however, this disclosure is not limited thereto, and it may also be another equipment.

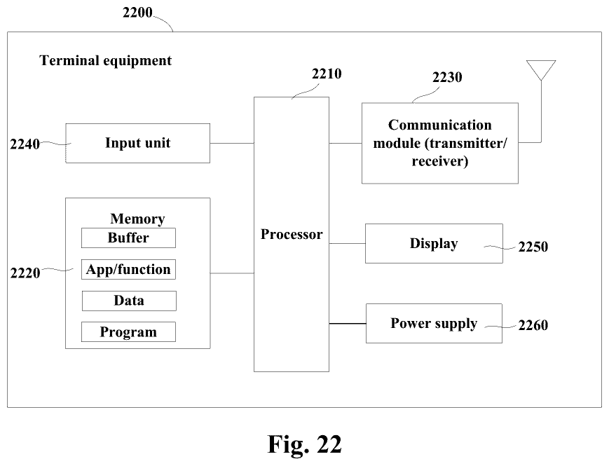

FIG. 22 is a schematic diagram of the terminal equipment of the embodiment of this disclosure. As shown in FIG. 22, a terminal equipment 2200 may include a processor 2210 and a memory 2220, the memory 2220 storing data and a program and being coupled to the processor 2210. It should be noted that this figure is illustrative only, and other types of structures may also be used, so as to supplement or replace this structure and achieve a telecommunications function or other functions.

For example, the processor 2210 may be configured to execute a program to carry out the method as described in the first aspect of embodiments. For example, the processor 2210 may be configured to perform the following control: receiving one or more reference signals to obtain measurement information; obtaining CSI according to the measurement information; and transmitting the CSI at a first time according to CSI report configuration, wherein the CSI at least indicates a channel state of a second time which is later than the first time.

As shown in FIG. 22, the terminal equipment 2200 may further include a communication module 2230, an input unit 2240, a display 2250, and a power supply 2260; wherein functions of the above components are similar to those in the related art, which shall not be described herein any further. It should be noted that the terminal equipment 2200 does not necessarily include all the parts shown in FIG. 22, and the above components are not necessary. Furthermore, the terminal equipment 2200 may include parts not shown in FIG. 22, and the related art may be referred to.

An embodiment of this disclosure provides a computer program, which, when executed in a terminal equipment, will cause the terminal equipment to carry out the method as described in the first aspect of embodiments.

An embodiment of this disclosure provides a storage medium, including a computer program, which, when executed in a terminal equipment, will cause the terminal equipment to carry out the method as described in the first aspect of embodiments.

An embodiment of this disclosure provides a computer program, which, when executed in a network device, will cause the network device to carry out the method as described in the first aspect of embodiments.

An embodiment of this disclosure provides a storage medium, including a computer program, which, when executed in a network device, will cause the network device to carry out the method as described in the first aspect of embodiments.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

As to implementations containing the above embodiments, following supplements are further disclosed.

1. A method for reporting channel state information (CSI), comprising:

receiving, by a terminal equipment, one or more reference signals to obtain measurement information;

obtaining CSI according to the measurement information; and

transmitting the CSI at a first time according to CSI report configuration, wherein the CSI at least indicates a channel state of a second time which is later than the first time.

2. The method according to supplement 1, wherein the method further comprises:

receiving, by the terminal equipment from a network device, at least one of first prediction indication, first prediction accuracy information or first prediction step information.

3. The method according to supplement 2, wherein the first prediction indication is used to indicate the terminal equipment to predict CSI of the second time; the first prediction accuracy information is used for indicating one or more prediction accuracy requirement; the first prediction step information is used to denote a time interval between the first time and the second time.

4. The method according to supplement 2 or 3, wherein the first prediction indication and/or the first prediction accuracy information are/is transmitted via at least one of radio resource control (RRC), media access control (MAC) control element (CE), or downlink control information (DCI).

5. The method according to any one of supplements 2-4, wherein the first prediction step information is scaled based on subcarrier spacing (SCS).

6. The method according to any one of supplements 2-5, wherein the first prediction step information is transmitted via at least one of radio resource control (RRC), media access control (MAC) control element (CE), or downlink control information (DCI).

7. The method according to any one of supplements 1-6, wherein the method further comprises:

transmitting, by the terminal equipment to a network device, a request for indicating at least one of reference signal periodicity, reference signal interval or reference signal number, or mobility indication.

8. The method according to supplement 7, wherein the reference signal periodicity is used by the network device to determine periodic configuration or semi-persistent configuration of the one or more reference signals.

9. The method according to supplement 7, wherein the reference signal interval or reference signal number or mobility indication is used by the network device to determine number and/or positions of aperiodic reference signals.

10. The method according to any one of supplements 1-9, wherein the method further comprises:

receiving, by the terminal equipment from a network device, the CSI report configuration and/or reference signal resource configuration.

11. The method according to supplement 10, wherein at least one of first prediction indication, first prediction accuracy information or first prediction step information are comprised in the CSI report configuration;

and the reference signal resource configuration is determined by the network device according to at least one of reference signal periodicity, reference signal interval, reference signal number, or mobility indication.

12. The method according to any one of supplements 1-11, wherein the method further comprises:

determining, by the terminal equipment, CSI prediction is not supported;

transmitting, by the terminal equipment to a network device, a prediction stop request; and

receiving, by the terminal equipment from the network device, a prediction stop response.

13. The method according to any one of supplements 1-11, wherein the method further comprises:

receiving, by the terminal equipment from a network device, a prediction stop indication.

14. The method according to any one of supplements 1-13, wherein the method further comprises:

receiving, by the terminal equipment from a network device, a capability inquiry; and

reporting, by the terminal equipment to the network device, a capability response.

15. The method according to supplement 14, wherein the capability inquiry is used for retrieving at least one of CSI prediction capability, AI/ML capability for CSI measurement or CSI prediction, CSI measurement or CSI prediction for a certain QoS or a reliability level request, CSI measurement or CSI prediction for a certain QoS or a reliability level request via AI/ML, CSI measurement or CSI prediction for a certain CSI delay.

16. The method according to supplement 14 or 15, wherein AI/ML related information is comprised in the capability inquiry, and/or, AI/ML related information is comprised in the capability response.

17. The method according to any one of supplements 14-16, wherein the method further comprises:

receiving, by the terminal equipment from the network device, activation information to trigger periodic CSI report through CSI report configuration, and/or to trigger semi-persistent CSI report through MAC CE or DCI, and/or to trigger aperiodic CSI report through DCI.

18. The method according to supplement 17, wherein information of enabling or disabling AI/ML is comprised in the CSI report configuration.

19. The method according to supplement 1, wherein the method further comprises:

transmitting, by the terminal equipment to a network device, second prediction indication; wherein the second prediction indication is used to indicate that the terminal equipment is to predict CSI of the second time.

20. The method according to supplement 1 or 19, wherein the method further comprises:

transmitting, by the terminal equipment to the network device, at least one of second prediction accuracy information, second prediction step information, reference signal configuration ID, reference signal interval, reference signal number, or mobility indication.

21. The method according to supplement 20, wherein reference signal resource configuration is determined by the network device according to at least one of the second prediction accuracy information, the second prediction step information, reference signal configuration ID, reference signal interval, reference signal number, or mobility indication.

22. The method according to supplement 1, wherein the method further comprises:

receiving, by the terminal equipment from a network device, reliability level indication;

wherein the reliability level indication is used to indicate the terminal equipment to obtain CSI for data transmission at the second time being able to match the request of the reliability level.

23. The method according to supplement 1 or 22, wherein the method further comprises:

receiving, by the terminal equipment from the network device, a request for retrieving CSI report capability with a reliability level indicator; and

reporting, by the terminal equipment to the network device, capability information on the CSI report capability with a reliability level indicator.

24. The method according to supplement 1 or 23, wherein the method further comprises:

receiving, by the terminal equipment from the network device, the CSI report configuration and/or reference signal resource configuration, wherein CSI delay information is comprised in the CSI report configuration.

25. The method according to any one of supplements 1-24, wherein CSI delay information is scaled based on subcarrier spacing (SCS).

26. The method according to supplement 1, wherein the method further comprises:

receiving, by the terminal equipment from a network device, CSI delay information;

wherein the CSI delay information is used to indicate the terminal equipment to obtain CSI of the second time.

27. The method according to any one of supplements 1-26, wherein differential CSI is used to indicates the channel state of the second time.

28. A method for receiving channel state information (CSI), comprising:

transmitting, by a network device, one or more reference signals according to reference signal resource configuration; and

receiving CSI at a first time, wherein the CSI at least indicates a channel state of a second time which is later than the first time.

29. The method according to supplement 27, wherein the method further comprises:

transmitting, by the network device to a terminal equipment, at least one of first prediction indication, first prediction accuracy information or first prediction step information.

30. The method according to supplement 29, wherein the first prediction indication is used to indicate the terminal equipment to predict CSI of the second time; the first prediction accuracy information is used for indicating one or more prediction accuracy requirement; the first prediction step information is used to denote a time interval between the first time and the second time.

31. The method according to supplement 29 or 30, wherein the first prediction indication and/or the first prediction accuracy information are/is transmitted via at least one of radio resource control (RRC), media access control (MAC) control element (CE), or downlink control information (DCI).

32. The method according to any one of supplements 29-31, wherein the first prediction step information is scaled based on subcarrier spacing (SCS).

33. The method according to any one of supplements 29-32, wherein the first prediction step information is transmitted via at least one of radio resource control (RRC), media access control (MAC) control element (CE), or downlink control information (DCI).

34. The method according to any one of supplements 28-33, wherein the method further comprises:

receiving, by the network device from the terminal equipment, a request for indicating at least one of reference signal periodicity, reference signal interval, reference signal number, or mobility indication.

35. The method according to supplement 34, wherein the reference signal periodicity is used by the network device to determine periodic configuration or semi-persistent configuration of the one or more reference signals.

36. The method according to supplement 34, wherein the reference signal interval or reference signal number or mobility indication is used by the network device to determine number and/or positions of aperiodic reference signals.

37. The method according to any one of supplements 28-36, wherein the method further comprises:

transmitting, by the network device to the terminal equipment, the CSI report configuration and/or reference signal resource configuration.

38. The method according to supplement 37, wherein at least one of first prediction indication, first prediction accuracy information or first prediction step information is/are comprised in the CSI report configuration;

and the reference signal resource configuration is determined by the network device according to at least one of reference signal periodicity, reference signal interval, reference signal number, or mobility indication.

39. The method according to any one of supplements 28-38, wherein the method further comprises:

receiving, by the network device from the terminal equipment, a prediction stop request; and

transmitting, by the network device to the terminal equipment, a prediction stop response.

40. The method according to any one of supplements 28-38, wherein the method further comprises:

determining, by the network device, CSI prediction is not supported;

transmitting, by the network device to the terminal equipment, a prediction stop indication.

41. The method according to any one of supplements 28-40, wherein the method further comprises:

transmitting, by the network device to the terminal equipment, a capability inquiry; and

receiving, by the network device from the terminal equipment, a capability response.

42. The method according to supplement 41, wherein the capability inquiry is used for retrieving at least one of CSI prediction capability, AI/ML capability for CSI measurement or CSI prediction, CSI measurement or CSI prediction for a certain QoS or a reliability level request, CSI measurement or CSI prediction for a certain QoS or a reliability level request via AI/ML, CSI measurement or CSI prediction for a certain CSI delay.

43. The method according to supplement 41 or 42, wherein AI/ML related information is comprised in the capability inquiry, and/or, AI/ML related information is comprised in the capability response.

44. The method according to any one of supplements 41-43, wherein the method further comprises:

receiving, by the terminal equipment from the network device, activation information to trigger periodic CSI report through CSI report configuration, and/or to trigger semi-persistent CSI report through MAC CE or DCI, and/or to trigger aperiodic CSI report through DCI.

45. The method according to supplement 44, wherein information of enabling or disabling AI/ML is comprised in the CSI report configuration.

46. The method according to supplement 28, wherein the method further comprises:

receiving, by the network device from a terminal equipment, second prediction indication; wherein the second prediction indication is used to indicate that the terminal equipment is to predict CSI of the second time.

47. The method according to supplement 28 or 46, wherein the method further comprises:

receiving, by the network device, at least one of second prediction accuracy information, second prediction step information, reference signal configuration ID, reference signal interval, reference signal number, or mobility indication.

48. The method according to supplement 47, wherein reference signal resource configuration is determined by the network device according to at least one of the second prediction accuracy information, the second prediction step information, reference signal configuration ID, reference signal interval, reference signal number, or mobility indication.

49. The method according to supplement 28, wherein the method further comprises:

transmitting, by the network device to the terminal equipment, reliability level indication; wherein the reliability level indication is used to indicate the terminal equipment to obtain CSI of the second time.

50. The method according to supplement 28 or 49, wherein the method further comprises:

transmitting, by the network device to the terminal equipment, a request for retrieving CSI report capability with a reliability level indicator; and

receiving, by the network device from the terminal equipment, capability information on the CSI report capability with a reliability level indicator.

51. The method according to supplement 50, wherein the method further comprises:

transmitting, by the network device to the terminal equipment, the CSI report configuration and/or reference signal resource configuration, wherein CSI delay information is comprised in the CSI report configuration.

52. The method according to supplement 28, wherein the method further comprises:

transmitting, by the network device to the terminal equipment, CSI delay information;

wherein the CSI delay information is used to indicate the terminal equipment to obtain CSI of the second time.

53. The method according to any one of supplements 28-52, wherein CSI delay information is scaled based on subcarrier spacing (SCS).

54. The method according to any one of supplements 28-53, wherein differential CSI is used to indicates the channel state of the second time.

55. A terminal equipment, comprising a processor and a memory, wherein the memory containing instructions executable by the processor whereby the terminal equipment is operative to perform a method according to any one of supplements 1-27.

56. A network device, comprising a processor and a memory, wherein the memory containing instructions executable by the processor whereby the network device is operative to perform a method according to any one of supplements 28-54.

57. A computer program product being tangibly stored on a computer readable storage medium and including instructions which, when executed on a processor of a terminal device, cause the terminal equipment to perform a method according to any one of supplements 1-27.

58. A computer program product being tangibly stored on a computer readable storage medium and including instructions which, when executed on a processor of a network device, cause the network device to perform a method according to any one of supplements 28-54.

What is claimed is:

1. An apparatus for reporting channel state information (CSI), comprising:
a first receiver configured to receive one or more reference signals to obtain measurement information;
first processor circuitry configured to obtain CSI according to the measurement information; and
a first transmitter configured to transmit the CSI at a first time according to CSI report configuration, wherein the CSI at least indicates a channel state of a second time which is later than the first time.

2. The apparatus according to claim 1, wherein the first receiver is configured to receive at least one of first prediction indication, first prediction accuracy information or first prediction step information;
wherein the first prediction indication is used to indicate a terminal equipment to predict CSI of the second time; the first prediction accuracy information is used for indicating one or more prediction accuracy requirement; the first prediction step information is used to denote a time interval between the first time and the second time.

3. The apparatus according to claim 2, wherein the first prediction indication, the first prediction step information or the first prediction accuracy information is transmitted via at least one of radio resource control (RRC), media access control (MAC) control element (CE), or downlink control information (DCI).

4. The apparatus according to claim 2, wherein the first prediction step information is scaled based on subcarrier spacing (SCS).

5. The apparatus according to claim 1, wherein the first transmitter is configured to transmit a request for indicating at least one of reference signal periodicity, reference signal interval, reference signal number, or mobility indication;
wherein the reference signal periodicity and/or mobility indication is used by a network device to determine periodic configuration or semi-persistent configuration of the one or more reference signals; the reference signal interval and/or reference signal number and/or mobility indication is used by the network device to determine number and/or positions of aperiodic reference signals.

6. The apparatus according to claim 1, wherein the first receiver is configured to receive the CSI report configuration and/or reference signal resource configuration;
wherein at least one of first prediction indication, first prediction accuracy information or first prediction step information are comprised in the CSI report configuration; and the reference signal resource configuration is determined by a network device according to at least one of reference signal periodicity, reference signal interval, reference signal number, or mobility indication.

7. The apparatus according to claim 1, wherein the first processor circuitry is configured to determine that CSI prediction is not supported;
the first transmitter is configured to transmit a prediction stop request; and the first receiver is configured to receive a prediction stop response.

8. The apparatus according to claim 1, wherein the first receiver is configured to receive a prediction stop indication.

9. The apparatus according to claim 1, wherein the first receiver is configured to receive a capability inquiry; and the first transmitter is configured to report a capability response;
wherein the capability inquiry is used for retrieving at least one of CSI prediction capability, AI/ML capability for CSI measurement or CSI prediction, CSI measurement or CSI prediction for a certain QoS or a reliability level, CSI measurement or CSI prediction for a certain QoS or a reliability level via AI/ML, CSI measurement or CSI prediction for a certain CSI delay.

10. The apparatus according to claim 1, wherein the first transmitter is configured to transmit second prediction indication; wherein the second prediction indication is used to indicate that the terminal equipment is to predict CSI of the second time.

11. The apparatus according to claim 1, wherein the first transmitter is configured to transmit at least one of second prediction accuracy information, second prediction step information, reference signal configuration ID, reference signal interval, reference signal number, or mobility indication;
wherein reference signal resource configuration is determined by a network device according to at least one of the second prediction accuracy information, the second prediction step information, reference signal configuration ID, reference signal interval, reference signal number, or mobility indication.

12. The apparatus according to claim 1, wherein the first receiver is configured to receive reliability level indication; wherein the reliability level indication is used to indicate the terminal equipment to obtain CSI for data transmission at the second time being able to match a request of the reliability level.

13. The apparatus according to claim 12, wherein the first receiver is configured to receive a request for retrieving CSI report capability with a reliability level indicator; and the first transmitter is configured to report capability information on the CSI report capability with a reliability level indicator.

14. The apparatus according to claim 13, wherein the first receiver is configured to receive the CSI report configuration and/or reference signal resource configuration, wherein CSI delay information is comprised in the CSI report configuration.

15. The apparatus according to claim 1, wherein the first receiver is configured to receive CSI delay information; wherein the CSI delay information is used to indicate the terminal equipment to obtain CSI of the second time.

16. The apparatus according to claim 1, wherein differential CSI is used to indicates the channel state of the second time.

17. An apparatus for receiving channel state information (CSI), comprising:
a second transmitter configured to transmit one or more reference signals according to reference signal resource configuration; and
a second receiver configured to receive CSI at a first time, wherein the CSI at least indicates a channel state of a second time which is later than the first time.

18. The apparatus according to claim 17, wherein the second transmitter is configured to transmit at least one of first prediction indication, first prediction accuracy information or first prediction step information;
wherein the first prediction indication is used to indicate the terminal equipment to predict CSI of the second time; the first prediction accuracy information is used for indicating one or more prediction accuracy requirement; the first prediction step information is used to denote a time interval between the first time and the second time.

19. The apparatus according to claim 17, wherein the second receiver is configured to receive a request for indicating at least one of reference signal periodicity, reference signal interval, reference signal number, or mobility indication;
wherein the reference signal periodicity or mobility indication is used by a network device to determine periodic configuration or semi-persistent configuration of the one or more reference signals;
the reference signal interval or reference signal number or mobility indication is used by the network device to determine semi-persistent configuration or aperiodic configuration of the one or more reference signals.

20. A network system, comprising:
a terminal equipment configured to receive one or more reference signals to obtain measurement information; obtain CSI according to the measurement information; and transmit the CSI at a first time according to CSI report configuration;
a network device configured to transmit one or more reference signals according to reference signal resource configuration; and receive the CSI at the first time; wherein the CSI at least indicates a channel state of a second time which is later than the first time.
